(19) United States
(12) Patent Application Publication
(10) Pub. No.: US 2023/0025494 A1
(43) Pub. Date: Jan. 26, 2023

(54) ILLUMINATED CAR WASH WAND

(71) Applicant: Calvin Isley, Grande Prairie (CA)

(72) Inventor: Calvin Isley, Grande Prairie (CA)

(21) Appl. No.: 17/443,864

(22) Filed: Jul. 28, 2021

(30) Foreign Application Priority Data
Jul. 23, 2021 (CA) 3126084

(51) Int. Cl. B60S 3/04; B08B 3/02; B08B 13/00; H01M 50/247; B05B 9/01; B05B 15/00; B05B 12/00; F21S 9/02; F21V 33/00; F21V 23/00; F21V 23/04

(52) U.S. Cl. CPC B60S 3/044; B08B 3/026; B08B 13/00; H01M 50/247; B05B 9/01; B05B 15/00; B05B 12/004; F21S 9/02; F21V 33/0004; F21V 23/007; F21V 23/0492; H01M 2220/30

(57) ABSTRACT

A water spray wand comprises an internal water pipe, a spray handle, a compartment for a battery and a light. The spray handle is configured such that when the flow of water is permitted through the spray wand, the electronic communication between the battery compartment and the light is completed, and when the flow of water through the spray wand is interrupted, a timer is activated to interrupt the electronic communication between the battery compartment after a predetermined delay.

### BACKGROUND

### 1. Technical Field

This disclosure relates generally to the field of hand held washer nozzles.

### 2. Description of Related Art

When using a spray washer during minimal ambient light is, the user cannot see with ease whether the area is clean or requires further washing. Many vehicles have hard to reach places, such as in the wheelbase, where dirt and mud accumulate and also extra light is required in order to see whether the dirty location is sufficiently clean. Thus, there is a need in the art for a convenient source of light when using washer.

### SUMMARY OF THE DISCLOSURE

According to a first embodiment, there is disclosed a water spray wand comprising an internal water pipe, a spray handle, a compartment for a battery and a light. The spray handle is configured such that when the flow of water is permitted through the spray wand, the electronic communication between the battery compartment and the light is completed, and when the flow of water through the spray wand is interrupted, a timer is activated to interrupt the electronic communication between the battery compartment after a predetermined delay.

The battery compartment may be external to the wand. The water spray wand may further comprise a housing to house the light. The housing may be connected to a distal end of the water spray wand. The lights may be oriented on a foreword face of the housing. The housing may include a cover selectably enclosing a rearward face of the housing.

The water spray wand may further comprise a plurality of lights. The housing may comprise a circular cross-section. The plurality of light may be arranged around the perimeter of the housing.

The batteries may be arranged within the housing alternating between the lights. The battery compartment may be located internally within the wand. The light may be positioned such that the target of the water flow exiting the spray wand is illuminated when the light is lit. The light may be an LED light.

The water spray wand may further comprise a controller adapted to control the electrical connection between the battery and the light. The water spray wand may further comprise a vibration sensor operably connected to the controller to detect the flow of water through the water spray wand. The water spray wand may further comprise a switch operably connected to the controller to detect when spray handle has been activated to permit water through the water spray wand.

Other aspects and features of the present disclosure will become apparent to those ordinarily skilled in the art upon review of the following description of specific embodiments in conjunction with the accompanying figures.

### BRIEF DESCRIPTION OF THE DRAWINGS

The accompanying drawings constitute part of the disclosure. Each drawing illustrates exemplary aspects wherein similar characters of reference denote corresponding parts in each view,

FIG. 1 is a side view showing the components of an embodiment of a spray nozzle with light.

FIG. 2 is a top view showing the components of an embodiment of the head of a spray nozzle with light.

FIG. 3 is a rear view showing the components of an embodiment of the head of a spray nozzle with light.

FIG. 4 is a wiring diagram an embodiment of the spray head with lights.

### DETAILED DESCRIPTION

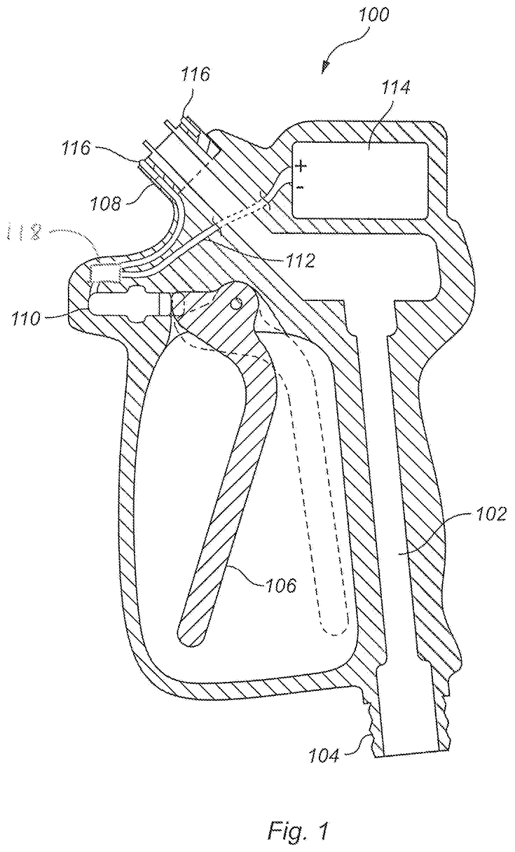

Aspects of the present disclosure are now described with reference to exemplary apparatuses, methods and systems. Referring to FIG. 1, an exemplary wand with light is shown generally at 100. The wand 100 comprises many of the components found in a currently commercially available spray nozzles. For example, the wand 100 comprises an internal water pipe 102 that allows for water to flow from a proximal intake point 104 to a distal exit point 108. In certain embodiments, the proximal intake point 104 is configured to attach onto a hose or other source of water flow. In some embodiments, the proximal intake point 104 is threaded and is configured to screw onto a hose. In other embodiments the proximal intake point 104 comprises clasps or hooks.

The diameter of the water pipe 102 can vary according to the size of the spray wand 100. In some embodiments, the water pipe 102 has a wide diameter, for example greater than 1.5″, to accommodate a heavy water flow, and in other embodiments the water pipe 102 has a narrow diameter, for example less than 0.75″. In certain embodiments the pipe 102 is encased by the wand 100 and in other embodiments the pipe 102 is exposed.

In some embodiments, the wand 100 comprises a spray handle 106. Once pressed, the spray handle allows water to flow through the pipe 102 to the distal exit point 108. In some embodiments, the handle is configured to lock in the pressed position for long time use, and then released when the use is completed.

In some embodiments, the wand 100 comprises a compartment for a battery 114. In some embodiments, the battery compartment is located internally within the wand 100, whereas in other embodiments the battery compartment is external to the wand 100. The battery compartment is configured to hold a battery 114 and provide electronic communication between the battery 114 and other components of the wand 100, as described below. The battery compartment may be configured to accommodate one or more batteries of various shapes and sizes, for example AAA, AA, D, 9 V, etc.

In some embodiments, battery 114 is a rechargeable battery. In some embodiments, the wand 100 comprises a wire that allows for the wand 100 to plug into a wall socket so the battery 114 can be recharged. In some embodiments, the battery 114 is recharged using solar energy. In these embodiments, the wand 100 comprises a solar panel in electronic communication with a charger and the battery 114.

The wand 100 comprises at least one light 116 located in proximity to the distal exit point 108. In some embodiments, the light 116 is positioned such that the target of the water flow exiting the exit point 108 is illuminated when the light 116 is lit.

The light 116 is in electronic communication through wires 112 with a controller 118 as illustrated in FIG. 4. The controller 118 may be of any suitable type, including a microprocessor, integrated circuit or printed circuit board adapted to perform the herein disclosed functions. In some embodiments, the controller 118 is in communication with a switch 110 and the battery 114 through the extension of wires 112. Thus, when the switch 110 is in the “on” position, the controller 118 is configured to enable electronic communication between the battery 114 and the light 116 such that the light 116 is lit. When the switch 110 is in the “off” position, the controller 118 is configured to begin a timer to interrupt electronic communication between the battery 114 and the light 116 after which time the light 116 is off. As illustrated in FIG. 1, the handle 106 is attached to the light switch 110. In other embodiments, the controller 118 is communication with a vibrations senor 120 (shown in FIG. 4) wherein the controller is adapted to enable electronic communication between the battery 114 and the light 116 when the sensor detects vibration in the wand 100. Such vibration may be provided due to water flowing through the wand. It will be appreciated that in such embodiments, the controller is not activated by the spray handle, but rather when a user activates water flowing through the want with the spray handle, the vibration due to the water flowing through the wand. Such embodiments may also include an optional shut off switch to prevent other vibrations from activating the lights 116.

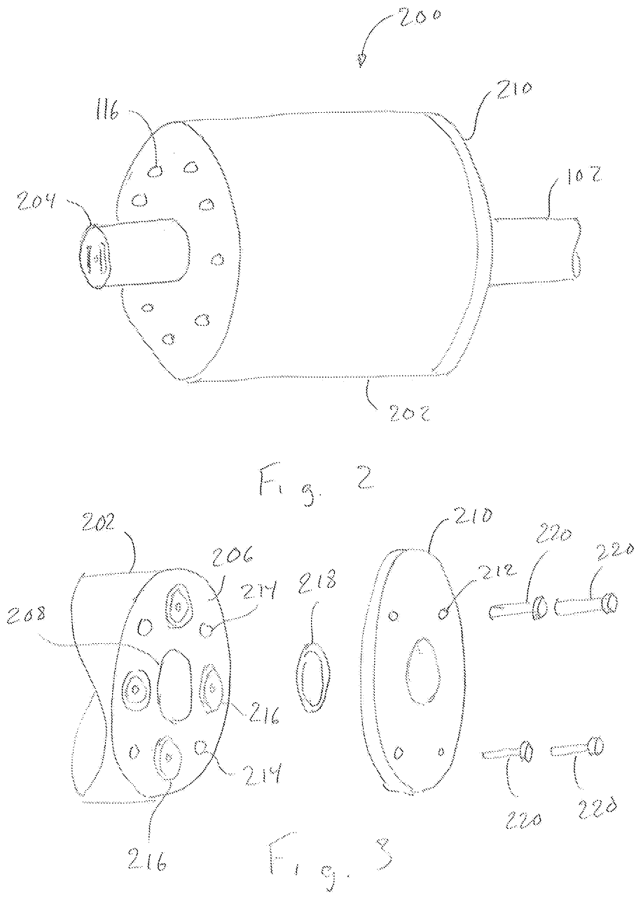

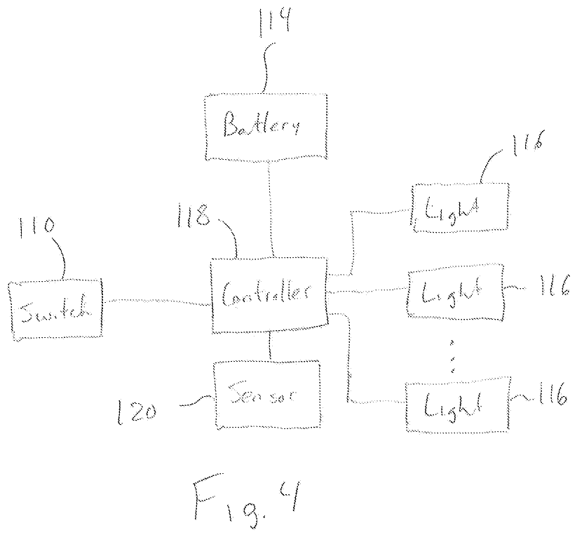

In the embodiment shown in FIG. 1, the light 116 is built into the wand 100. In other embodiments, for example those shown in FIGS. 2 and 3, the light 116 is contained in a housing 202, which in turn can be attached to the wand 100, as described below.

FIG. 2 shows one embodiment of the nozzle 200. The nozzle 200 is located at the exit point 108 and is connected to the pipe 102. The nozzle 200 comprises a housing 202 for the light 116. In this particular embodiment, the housing 202 has a substantially circular cross section and is in a substantially cylindrical. In other embodiments, the housing 202 may be any other shape as well including conical. Other embodiments include those in which the housing 202 has cross sections with other geometrical shapes, for example regular shapes such as triangles or polygons, or irregular shapes.

In some embodiments, the nozzle 200 comprises an outlet 204 from which the water exits the wand 100. In some embodiments (not shown), the distal end of the outlet 204 is coplanar with the distal end of the housing 202. In other embodiments, for example that shown in FIG. 2, the outlet 204 protrudes distally from the housing 202, such as the distal end of the outlet 204 is at a distance further distal than the distal end of the housing 202.

In certain embodiments the outlet 204 is detachable. In some embodiments, the housing 202 is detachable. In some embodiments, the outlet 204 can be changed for different spray forces or shapes. In other embodiments the housing 202 is fixed.

The presently disclosed wands 100 comprise at least one light 116 located at the distal end of the wand 100. The light 116 shines in the direction of the water and allows the user of the wand 100 to see where the water is being sprayed. In some embodiments, the light 116 is housed in the housing 202.

In some embodiments (not shown), the housing 202 comprises a single light 116. In other embodiments, for example that shown in FIG. 2, the housing 202 comprises a plurality of lights 116. In certain embodiments, for example that shown in FIG. 2, the plurality of lights 116 are arranged in a circle along the perimeter of the distal end of the housing 202.

In other embodiments, the lights 116 are clustered in various ways including but not limited to, i) one or more lights at 0°, ii) one or more lights at 0° and one or more lights at 180°, iii) one or more lights at 0°, one or more lights at 90°, one or more lights at 180°, and one or more lights at 270°, iv) one or more lights at 0°, one or more lights at 120°, and one or more lights at 240°, and the like. The degrees above refer to the degrees around the circle defined by the top of the housing 202.

In certain embodiments, the lights 116 are fixed onto the housing 202, and in other embodiments the lights 116 are detachable for daylight use. In some embodiments the lights 116 have a fixed illumination direction. In other embodiments the lights 116 can be moved to light areas surrounding the spray target.

FIG. 3 shows an exploded view of the nozzle 200. The housing 202 includes a rear surface 206 opposite to the lights 116. Nozzle 200 further includes a rear cap 210 enclosing the rear surface 206. As illustrated in FIG. 3, the rear surface includes fastener bores 214 therein adapted to receive fasteners 220 passing through corresponding bores 212 in the rear cap 210. The fasteners retain the rear cap against the rear surface 206 to enclose it. The housing may further include a passage 208 adapted to pass the outlet 204 therethrough. An O-ring 218 or other suitable seal may seal the housing against the outlet 204. As illustrated batteries 216 may also be included within the housing in any desired arrangement. As illustrated, the batteries may be alternating with the bores 214 although other arrangements may also be utilized.

In certain embodiments the light 116 is an LED light. In other embodiments the light 116 is another type of light, for example those having neon, fluorescent, ultraviolet or incandescent bulbs.

While specific embodiments have been described and illustrated, such embodiments should be considered illustrative only and not as limiting the disclosure as construed in accordance with the accompanying claims.

What is claimed is:

1. A water spray wand comprising:
an internal water pipe;
a spray handle;
a compartment for a battery;
a light,
wherein the spray handle is in electronic communication with both the light and the battery compartment, and
wherein the spray handle is configured such that when the flow of water is permitted through the spray wand, the electronic communication between the battery compartment and the light is completed, and when the flow of water through the spray wand is interrupted, a timer is activated to interrupt the electronic communication between the battery compartment after a predetermined delay.

2. The water spray wand of claim 1, wherein the battery compartment is external to the wand.

3. The water spray wand of claim 1, further comprising a housing to house the light.

4. The water spray wand of claim 3, wherein the housing is connected to a distal end of the water spray wand.

5. The water spray wand of claim 3, wherein the lights are oriented on a foreword face of the housing.

6. The water spray wand of claim 3, wherein the housing includes a cover selectably enclosing a rearward face of the housing.

7. The water spray wand of claim 1, comprising a plurality of lights.

8. The water spray wand of claim 3, wherein the housing comprises a circular cross-section.

9. The water spray wand of claim 8, wherein the plurality of light are arranged around the perimeter of the housing.

10. The water spray wand of claim 9, wherein the batteries are arranged within the housing alternating between the lights.

11. The water spray wand of claim 1, wherein the battery compartment is located internally within the wand.

12. The water spray wand of claim 1, wherein the light is positioned such that the target of the water flow exiting the spray wand is illuminated when the light is lit.

13. The water spray wand of claim 1, wherein the light is an LED light.

14. The water spray wand of claim 1 further comprising a controller adapted to control the electrical connection between the battery and the light.

15. The water spray wand of claim 14 further comprising a vibration sensor operably connected to the controller to detect the flow of water through the water spray wand.

16. The water spray wand of claim 1 further comprising a switch operably connected to the controller to detect when spray handle has been activated to permit water through the water spray wand.
